(19) United States
(12) Patent Application Publication
(10) Pub. No.: US 2020/0316903 A1
(43) Pub. Date: Oct. 8, 2020

(54) Coated Garnet Particle Product, Tire Containing, and Method of Manufacturing

(71) Applicant: James I. Scheller, Powell Butte, OR (US)

(72) Inventor: James I. Scheller, Powell Butte, OR (US)

(21) Appl. No.: 16/377,115

(22) Filed: Apr. 5, 2019

(51) Int. Cl. B32B 5/02; B60C 1/00

(52) U.S. Cl. CPC B32B 5/02; B60C 2011/147; B60C 1/0016

(57) ABSTRACT

A coated garnet particle product may include garnet particles and at least one coating that coats the garnet particles and that includes a bonding agent. The combination of the garnet particles and the at least one coating defines a plurality of coated garnet particles. The coated garnet particles may be suitable for mixing with tire rubber formulations for incorporation into a tire tread of a tire with at least some of the coated garnet particles partially protruding from the tire tread for engaging road surfaces when the tire is in use on the road surfaces, thereby increasing wear and gripping capabilities of the tire on dry, wet, icy, or snowy road conditions. The bonding agent may reduce loss of coated garnet particles due to road friction when in use on various road surfaces and increase wear and traction relative to a tire with uncoated garnet particles or no garnet particles.

### TECHNICAL FIELD

Certain embodiments pertain to a coated garnet particle product configured for being incorporated into tire treads. In particular certain embodiments pertain to a coated garnet particle product configured for increasing wear and gripping capabilities of tire treads on dry, wet, icy, or snowy road conditions when incorporated into the tire treads.

### BACKGROUND

Many tires are not suitable for driving conditions involving snowy or icy conditions. Attempts to provide for greater tire traction in snowy or icy conditions have taken different approaches. In a first approach, add-on tire traction devices have been developed which can be attached to a tire when needed for snowy or icy conditions. These add-on tire traction devices include, for example, tire chains, tire cables, and the like. While these do provide tire traction in some snowy or icy conditions, they have a number of disadvantages. They must be carried in the vehicle, thereby taking up space in the vehicle, when it is not snowy or icy so that they can be ready to be deployed if snowy or icy conditions are confronted. Also, they must often be purchased for specific tire sizes. If a consumer makes an error in buying the correct size, the purchased tire traction devices could be useless if they cannot be installed on the tire when needed. And, there is often a certain level of knowledge and skill to placing these on a tire when needed.

Another approach has been to incorporate traction-providing fillers into tire treads. Some of these fillers for example have been walnut shells, wire, fiberglass, aluminum oxide, and the like. Such tires however have not been found to be satisfactory in having the combined required features of long wear, economy of manufacture, and good road traction.

Tires have also been provided with metal or rubber studs but these traction devices are noisy, are illegal in some states, and where legal can only be used in winter months. Moreover, while studded tires provide traction in some snowy and icy condition, they provide less satisfactory traction in rainy or dry pavement conditions. In addition, studded tire are known to wear out road surfaces, especially when driven on pavement during rainy or dry pavement conditions.

Applicant now discusses U.S. Pat. No. 4,082,131 “Tire Tread Structure” by James I. Scheller (the “Scheller I”). Scheller I describes a tire tread structure that included garnet particles. This tire tread structure was described as combining features of long wear, of being reasonably economical to manufacture, of having good road traction, and generally of being legal in all states the year around. The described tire tread was formed by the intermixing of garnet particles with a rubber compound which was then used to make tire tread so that the tire has improved traction with the road surface and at the same time has long wearing qualities and other features mentioned. The described particle size was said to vary but it was said that the amount of garnet used be used should be at least 10% by weight of the rubber in the tread.

While the tire tread structure described in Scheller I has advantages, it also has disadvantages. In particular when a tire tread with the garnet particles of Scheller I are used on a road, and the garnet particles are in contact with a road surface, the friction with the road surface (or with snow or ice) causes some of the garnet particles to prematurely come lose from the tire tread. This premature loss of these garnet particles from the tire tread reduces some of the benefits of this tire tread. For example, there is decreased traction and decreased wear. Thus, there is a need for a solution to reduce the above premature loss of garnet particles while providing a tire that provides good wear and traction in all seasons.

### SUMMARY

This summary is provided as a convenience to the reader as a summary of one or more embodiments. The discussion in this Summary is intentionally simplified. It is not intended as a guide for construing or limiting the scope of the claims.

Some embodiments include a coated garnet particle product that includes at least a plurality of garnet particles and at least one coating that individually coats the garnet particles of the plurality of garnet particles, the at least one coating including at least a bonding agent. In these embodiments the plurality of garnet particles and the at least one coating defines a plurality of coated garnet particles. The plurality of coated garnet particles may be suitable for mixing with one or more tire rubber formulations for incorporation into one or more tire treads of one or more tires with at least some of the plurality of coated garnet particles partially protruding from the one or more tire treads for engaging one or more road surfaces when the one or more tires are in use on the one or more road surfaces thereby increasing wear and gripping capabilities of the one or more tires on dry, wet, icy, or snowy road conditions. In some embodiments, the bonding agent is a bonding agent for elastomers that is configured to adhere to said tire rubber formulations after said mixing and subsequent heating and pressurization as part of a tire vulcanization process. Thus, after the tire vulcanization process, the incorporation of the plurality of coated garnet particles into the one or more tire treads of the one or more tires, and upon the use of the one or more tires on the one or more road surfaces, the plurality of coated garnet particles adhere more strongly to said one or more tire threads than would uncoated garnet particles. Loss of some of the plurality of coated garnet particles from road friction is thus reduced relative to a loss of uncoated garnet particles from road friction and the wear and gripping capabilities of the one or more tires on the one or more road surfaces is thereby increased relative to wear and gripping capabilities of tires with uncoated garnet particles.

Some embodiments include a garnet tire that provides secure gripping on a variety of road conditions, including on icy, snowy, wet, and dry road conditions. In some embodiments, the garnet tire includes at least a tire tread and a plurality of coated garnet particles embedded throughout the tire tread of said garnet tire with at least some of the plurality of coated garnet particles partially protruding from a tire tread surface of said tire tread for gripping one or more road surfaces when the garnet tire is mounted to a moving motor vehicle for operation on the one or more road surfaces. In these embodiments, the plurality of coated garnet particles includes at least one coating that individually coats the garnet particles of the plurality of garnet particles and that includes at least a bonding agent configured to adhere to elastomers under heat and pressure of a vulcanization process. In some embodiments, because of the at least one coating the coated garnet particles adhere more strongly to the tire tread of the tire relative to uncoated garnet particles. Thus, loss of coated garnet particles from road friction is reduced relative to a tire having uncoated garnet particles. And the coated garnet particles configure the tire for an increased gripping capability on road surfaces relative to a gripping capability of a tire with uncoated garnet particles.

In some embodiments, a method of manufacturing a coated garnet particle product, includes at least rinsing a plurality of garnet particles and applying a forced air stream to the plurality of garnet particles to create a static charge on the plurality of garnet particles. In some embodiments the method of manufacturing further includes mixing the plurality of garnet particles with at least a silane primer and allowing to dry, the plurality of garnet particles being mixed with a silane primer that is an oil-derived or synthetic polymer that is configured to further clean the plurality of garnet particles and prepare the plurality of garnet particles for application of a bonding agent. In some embodiments, the method further includes mixing the plurality of garnet particles with at least a bonding agent that is a bonding agent for elastomers that includes at least a polymer-adhesive organic solvent and allowing to dry.

### BRIEF DESCRIPTION OF THE FIGURES

Various embodiments will now be described, by way of example, with reference to the accompanying drawings. It should be noted that these drawings are not necessarily to scale. In particular, for purposes of illustration, the garnet particles depicted are enlarged relative to their actual size in various embodiments. Regarding the size of garnet particles in various embodiments, the reader should rely not on the sizes of garnet particles as depicted in these figures, but should instead rely on the discussion of their size in the Detailed Description that follows. The figures are:

FIG. 1 is a perspective view of a conventional tire without garnet particles.

FIG. 2 is a perspective view, consistent with some embodiments, of a garnet tire showing coated garnet particles (enlarged for illustration) protruding from a tire tread.

FIG. 3A is a side view, consistent with some embodiments, of a plurality of garnet particles (enlarged) before application of any coatings.

FIG. 3B is a side view, consistent with some embodiments, of the plurality of garnet particles of FIG. 3A, but after application of a first coating that includes at least a silane primer.

FIG. 3C is a side view, consistent with some embodiments, of the plurality of garnet particles of FIGS. 3A and 3B, but after application of a second coating that includes at least a bonding agent.

FIG. 4A, is a close-up perspective view, consistent with some embodiments, of a garnet tire showing coated garnet particles (enlarged for illustration) protruding from a tire tread. A sectional line AA is indicated showing the view of FIG. 4B.

FIG. 4B is a sectional view two-dimensional view of the garnet tire of FIG. 4B, showing a section viewed consistent with the sectional line of FIG. 4A.

FIG. 5 is a method flow chart illustrating a method (also described relative to FIGS. 3A-3C) consistent with some embodiments.

### DETAILED DESCRIPTION

Some embodiments are now described with reference to the above-described figures. In the following description, reference is often made to “some embodiments.” These references to “some embodiments” are not necessarily referring to the same embodiments, as numerous and varied embodiments are possible. In addition, the drawings are simplified drawings which omit various details to focus on what is described in this detailed description. The omission of various details is not intended to imply that these various details would not be present in an actual physical embodiment. Instead, omissions of various details are merely to avoid clutter in the presentation and to aid ease of explanation and understanding. Further, these simplified drawings are intended to illustrate the principles of various described embodiments and are not necessarily drawn to scale. In addition, as noted above, for purposes of illustration, the garnet particles depicted are enlarged relative to their actual size in various embodiments. Regarding the size of garnet particles in various embodiments, the reader should rely not on the sizes of garnet particles as depicted in these figures, but should instead rely on the discussion of their size in the discussion below.

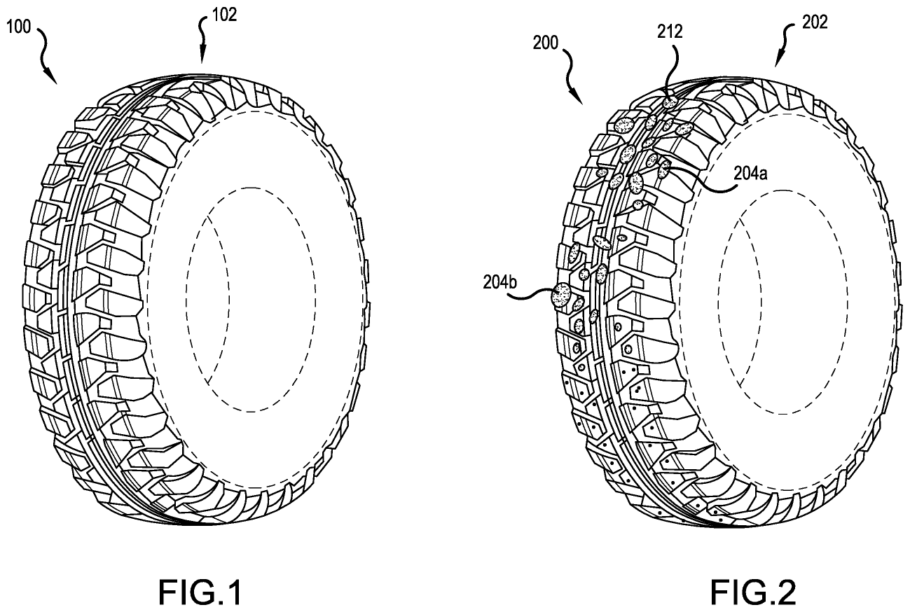

Preliminarily, various embodiments described herein related to coated garnet particles (i.e., coated garnet particle product) which may be incorporated into the tire tread of tires. Referencing FIGS. 1 and 2, a convention tire 100 with a conventional tire tread 102 may be contrasted with a garnet tire 200 with a tire tread 202 that includes coated garnet particles, such as coated garnet particles 204a, 204b. The garnet tire 200 has various advantages over a conventional tire 100. Whereas the garnet tire 200 provides traction on a variety of road surfaces, such as snow, ice, wet pavement, and dry pavement, the conventional tire does not provide reliable traction on snowy or icy conditions. Even if the conventional tire were equipped with metal or rubber studs (not shown), garnet tire 200 would still have the advantage that, unlike studded tires, it can be year-round in all seasons. Another advantage of garnet tire 200 over studded tires is that the garnet tire 200 produces far less pavement wear than studded tires.

The garnet tire 200 of FIG. 2 could also has advantages when contrasted with the tire described in the Scheller I patent (not shown), which contains only uncoated garnet particles in its tire tread. The advantages of garnet tire 200, compared to the tire of Scheller I, include reduced loss of garnet particles from tire treads due to road wear, thereby providing improved wear and gripping capabilities relative to tires incorporating only uncoated garnet particles.

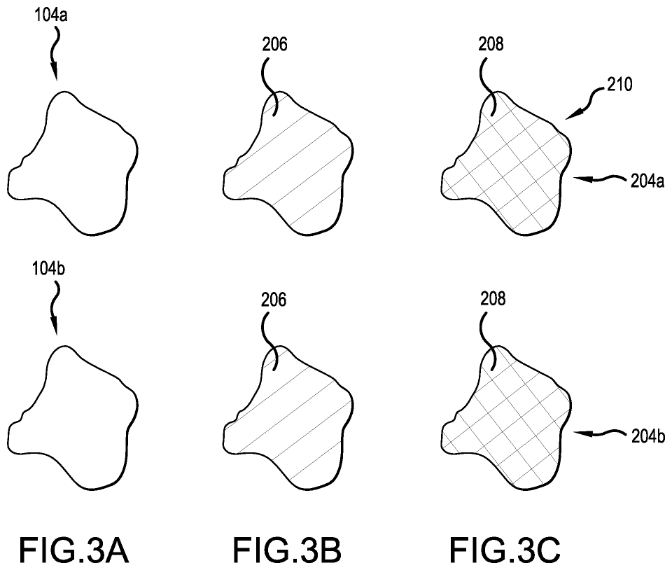

Turning to FIGS. 3A-3C, stages of producing a coated garnet particle product 210, consistent with some embodiments, are depicted, starting with FIG. 3A which shows a plurality of garnet particles 104a, 104b before any coating is applied. Then, FIG. 3B shows the plurality of garnet particles 104a, 104b, with a coating 206 that includes at least a silane primer, (at times also referred to as a “first coating” or an “additional coating”, depending on context). Finally, FIG. 3C shows the addition of a coating 208 that includes at least a bonding agent (at times below, also referred to as a “second coating” or an “at least one coating” that includes at least a bonding agent, depending on context). With the addition of second coating 208, the plurality of garnet particles are then coated garnet particles 204a, 204b of a coated garnet particle product 210.

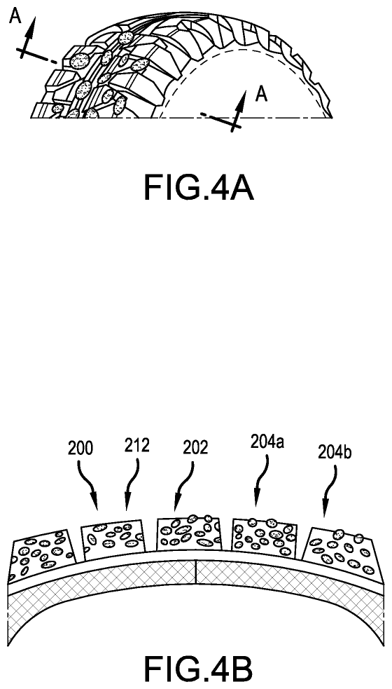

Turning now to FIGS. 4A and 4B, a cross-section of tire tread 202 of tire 200 is shown, consistent with some embodiments. Specifically, FIG. 4A shows the direction of cross-sectional cut (i.e., perpendicular to a circumference of tire 200). FIG. 4A shows tire 200, tire tread 202, tire tread surface 212, and a plurality of coated garnet particles 204a, 204b. In particular, it is shown that coated garnet particles (e.g., for example, 204a, 204b) are disposed throughout the tire tread 202, with at least coated garnet particles 204a, 204b protruding from tire tread surface 212 of tire tread 202. It should be noted that although only two coated garnet particles 204a, 204b are shown, in an actual garnet tire 200, many, many more would be present. As noted elsewhere, 204a and 204b are enlarged for ease of understanding of concepts.

In the discussion below, there is discussion of coated garnet particles. As is well-known, garnet is a semi-precious stone. On the MOHs Hardness scale, garnet ranges from about 6.5 to 7.5. And garnet typically has a specific gravity of about 3.5 to 4.3. Although any grade of garnet could be used, the garnet typically used in embodiments discussed herein is industrial grade garnet particles. In some embodiments, these garnet particles could be industrial grade garnet crystals. Also, while garnet particles having a high degree of purity could be used, the industrial grade garnet which is suitable for some embodiments does not require a high degree of purity. Enough purity to retain garnet's hardness as discussed above.

In the discussion below, there is discussion of tire rubber formulations. Many different types of tire formulations are known in the art. Some tire rubber formulations use natural rubber. Some use synthetic rubber. Some use additional chemicals, additives, or materials. Some tire rubber formulations are proprietary. Some are trade secrets of their respective manufacturer. For purposes of the various embodiments below, there is no intent to limit embodiments to any particular tire rubber formulations. Instead one having ordinary skill in the art when informed by the principles disclosed herein would be able to select from known tire rubber formulations without undue experimentation.

In the discussion below, there is discussion of garnet tires, consistent with some embodiments. Garnet tires, as described herein, can be any known type of tire, including without limitation radial tires, truck tires, SUV tires, all-season tires, all-terrain tires, passenger vehicle tires, snow tires, new tires, retread tires, and the like.

In addition, no particular method of tire manufacturing is required to practice embodiments of this invention. A method of manufacturing a coated garnet particle product is described and claimed below. Once the coated garnet particle product has been manufactured, it can be mixed with a tire rubber formulation (e.g., in a cement mixer or other type of industrial mixer). After that, there is no restriction on the type of manufacturing process that can be used. It should be noted that the coated garnet particles have a bonding agent that will bond to the tire rubber formulation during a heating process, such as a vulcanization process. Therefore, some form of heating is anticipated as part of the tire manufacturing process. For purposes of the various embodiments below, the type of tire manufacturing process used, after the coated garnet particles are mixed with the tire rubber formulation is immaterial—as long as some type of heating process similar to vulcanization is included. Since vulcanization is a standard part of tire manufacture, it is anticipated that any known tire manufacturing process would be suitable for having coated garnet particles incorporated into the tread thereof. For purposes of the various embodiments below, there is no intent to limit embodiments to any particular tire manufacturing processes. Instead one having ordinary skill in the art when informed by the principles disclosed herein would be able to select from known tire manufacturing processes without undue experimentation.

Referencing FIGS. 2, 3C, and 4B in some embodiments, a coated garnet particle product 210 includes at least a plurality of garnet particles 104a, 104b and at least one coating 208 that individually coats the garnet particles of the plurality of garnet particles, the at least one coating 208 including at least a bonding agent. In these embodiments, the combination of the plurality of garnet particles 104a, 104b and the at least one coating 208 defines a plurality of coated garnet particles 204a, 204b.

The plurality of coated garnet particles 204a, 204b are suitable for mixing with one or more tire rubber formulations (not shown) for incorporation into one or more tire treads 202 of one or more tires 200 with at least some of the plurality of coated garnet particles 204a, 204b partially protruding from the one or more tire treads for engaging one or more road surfaces (not shown) when the one or more tires 200 are in use on the one or more road surfaces thereby increasing wear and gripping capabilities of the one or more tires on dry, wet, icy, or snowy road conditions. In addition, the bonding agent (of the at least one coating 208) is a bonding agent for elastomers that is configured to adhere to said tire rubber formulations after said mixing and subsequent heating and pressurization as part of a tire vulcanization process.

Thus, after the tire vulcanization process, the incorporation of the plurality of coated garnet particles into the one or more tire treads of the one or more tires, and upon the use of the one or more tires on the one or more road surfaces, the plurality of coated garnet particles 204a, 204b adhere more strongly to said one or more tire threads (e.g., tire tread 202) than would uncoated garnet particles and thereby loss of some of the plurality of coated garnet particles 204a, 204b from road friction is reduced relative to a loss of uncoated garnet particles from road friction, and the wear and gripping capabilities of the one or more tires on the one or more road surfaces is thereby increased relative to wear and gripping capabilities of tires with uncoated garnet particles.

In some embodiments, the plurality of coated garnet particles 204a, 204b are configured to be mixed into tire rubber formulations at a ratio of between 5 and 15 percent by weight of tread rubber formulation. That is, the benefits described herein are achieved by a mixing of the plurality of coated garnet particles 204a, 204b with the tire rubber formulations at a ratio between 5 and 15 percent by weight of tread rubber formulation.

In some embodiments, at least some individual coated garnet particles 204a, 204b of the plurality of coated garnet particles 204a, 204b range in size between 8-200 mesh sizing. Mesh sizing is a standard measure well known to those of skill in the art. It describes a number of openings in a one-inch screen. Mesh sizing can be converted to inches, microns, and millimeters. For example, a mesh size of eight converts to a particle 0.937 inches in diameter, 2380 microns in diameter, or 2.380 millimeters in diameter. A mesh size of 200 converts to a particle diameter of 0.0029 inches, 74 microns, or 0.74 millimeters. The above conversions are taken from “MESH/INCH/MILLIMETER—CONVERSION CHART (U.S. STANDARD)” published by YAAX International Inc., of Yakima, Wash. (undated, but accessed online Mar. 19, 2019) (“YAAX chart”). The YAAX chart indicates that the naked eye visibility threshold is 40 microns.

In some embodiments, the bonding agent is a bonding agent for elastomers that includes at least a polymer-adhesive organic solvent. In some further embodiments, the polymer-adhesive organic solvent includes at least a nitrogen substituted aromatic crossliner of a natural or a synthetic blend.

In some embodiments, the at least one coating 208 includes at least an additional coating 206 that includes at least a silane primer, wherein the silane primer of the at least an additional coating is adhered directly to the garnet particles and the bonding agent of the at least one coating is adhered at least one of to the silane primer or to the garnet particles. In some embodiments, the silane primer of the at least an additional coating 206 is a residue remaining on at least some portions of at least some the garnet particles after evaporation of at least some of the silane primer prior to an application of the bonding agent.

In some embodiments, the silane primer includes at least an oil-derived or synthetic polymer that is configured to prepare the plurality of garnet particles for the bonding agent. In some embodiments, the oil-derived or synthetic polymer includes at least an organofunctional silane. In some further embodiments, the organofunctional silane includes at least one or more of toluene, n-butanol, or an ethanol.

In some embodiments, the at least one coating 208 is only a single coating that includes at least the bonding agent and the at least one coating does not include any additional coatings. For example, a first coating including a silane primer may have been applied before application of a bonding agent, but the silane primer having completely evaporated before application of the bonding agent.

Proceeding with reference to FIGS. 2, 4A, and 4B, embodiments are discussed that include one or more tires with coated garnet particles incorporated in the tire treads. In some embodiments, a garnet tire 200 provides secure gripping on a variety of road conditions, including on icy, snowy, wet, and dry road conditions. In some embodiments the garnet tire 200 includes at least a tire tread 202 and a plurality of coated garnet particles 204a, 204b embedded throughout the tire tread 202 of said garnet tire 200. At least some of the plurality of coated garnet particles 204a, 204b partially protruding from a tire tread surface 212 of said tire tread 202 for gripping one or more road surfaces (not shown) when the garnet tire 200 is mounted to a moving motor vehicle (not shown) for operation on the one or more road surfaces, the plurality of coated garnet particles 204a, 204b including at least one coating 208 that individually coats the garnet particles of the plurality of garnet particles and that includes at least a bonding agent. In some embodiments, because of the at least one coating 208 the coated garnet particles 204a, 204b adhere more strongly to the tire tread 202 of the tire 200 relative to uncoated garnet particles. Thus, in these embodiments, a loss of coated garnet particles from road friction is reduced relative to a tire having uncoated garnet particles and the coated garnet particles 204a, 204b configure the tire 200 for an increased gripping capability on road surfaces relative to a gripping capability of a tire with uncoated garnet particles.

In some embodiments, the garnet tire 200 is one of a truck tire or a passenger tire. In some embodiments, the garnet tire 200 is at least one of a retread tire or a new tire.

In some embodiments, the at least one coating 208 includes at least an additional coating 206 that includes at least a silane primer, wherein the silane primer of the at least an additional coating is adhered directly to the garnet particles and the bonding agent of the at least one coating is adhered at least one of to the silane primer or to the garnet particles.

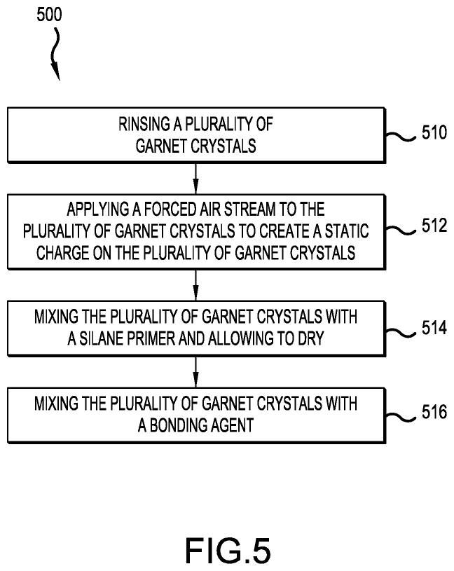

Now referencing FIGS. 3A, 3B, 3C, and 5, a method of manufacturing a coated garnet particle product 210 is now described. In some embodiments, a method 500 of manufacturing a coated garnet particle product 210 includes at least a rinsing operation 510 of rinsing a plurality of garnet particles 104a, 104b. In some embodiments the method 500 further includes a forced air stream operation 512 of applying a forced air stream to the plurality of garnet particles 104a, 104b to create a static charge on the plurality of garnet particles 104a, 104b. In some embodiments, the method further includes a first mixing operation 514 of mixing the plurality of garnet particles 104a, 104b with at least a silane primer 206 and allowing to dry. In some further embodiments, this first mixing operation includes mixing the plurality of garnet particles 104a, 104b with at least a silane primer that is an oil-derived or synthetic polymer that is configured to further clean the plurality of garnet particles and prepare the plurality of garnet particles 104a, 104b for application of a bonding agent 208. In some embodiments, the method further includes a second mixing operation 516 of mixing the plurality of garnet particles with at least a bonding agent 208 for elastomers that is a polymer-adhesive organic solvent and allowing to dry. This mixing operation 516 results in a plurality of coated garnet particles 204a, 204b, of the coated garnet particle product 210.

In some embodiments the first mixing operation 514 of mixing the plurality of garnet particles 104a, 104b with the at least a silane primer 206 includes at least mixing the plurality of garnet particles 104a, 104b with an organofunctional silane. In some further embodiments, mixing the plurality of garnet particles 104a, 104b with the organofunctional silane includes at least mixing the plurality of garnet particles 104a, 104b with an organofunctional silane that includes one or more of toluene, n-butanol, or an ethanol.

In some embodiments, the second mixing operation 516 of mixing the plurality of garnet particles 104a, 104b with the at least a bonding agent 206 for elastomers includes at least mixing the plurality of garnet particles with a nitrogen substituted aromatic crossliner of a natural or a synthetic blend. In some embodiments, the first mixing operation 514 of mixing the plurality of garnet particles 104a, 104b with at least a silane primer 206 includes at least one of dipping the plurality of garnet particles 104a, 104b in the at least a silane primer 206 or spraying the at least a silane primer 206 on the plurality of garnet particles 104a, 104b.

All of the products, tires, and/or methods disclosed and claimed herein can be made and used without undue experimentation in light of the present disclosure. The above discussion of some embodiments is not exhaustive. Instead, one having ordinary skill in the art will appreciate additional alternatives and/or modifications that may be made to the discussed embodiments without departing from the inventive principles. The invention is therefore not intended to be limited by the above discussion but only by the following claims.

I claim:

1. A coated garnet particle product comprising:
a plurality of garnet particles; and
at least one coating that individually coats the garnet particles of the plurality of garnet particles, the at least one coating including at least a bonding agent; and
wherein the combination of the plurality of garnet particles and the at least one coating defines a plurality of coated garnet particles;
wherein the plurality of coated garnet particles are suitable for mixing with one or more tire rubber formulations for incorporation into one or more tire treads of one or more tires with at least some of the plurality of coated garnet particles partially protruding from the one or more tire treads for engaging one or more road surfaces when the one or more tires are in use on the one or more road surfaces thereby increasing wear and gripping capabilities of the one or more tires on dry, wet, icy, or snowy road conditions;
wherein the bonding agent is bonding agent for elastomers that configured to adhere to said tire rubber formulations after said mixing and subsequent heating and pressurization as part of a tire vulcanization process;
wherein, after the tire vulcanization process, the incorporation of the plurality of coated garnet particles into the one or more tire treads of the one or more tires, and upon the use of the one or more tires on the one or more road surfaces, the plurality of coated garnet particles adhere more strongly to said one or more tire threads than would uncoated garnet particles and thereby loss of some of the plurality of coated garnet particles from road friction is reduced relative to a loss of uncoated garnet particles from road friction, and the wear and gripping capabilities of the one or more tires on the one or more road surfaces is thereby increased relative to wear and gripping capabilities of tires with uncoated garnet particles.

2. The coated garnet particle product of claim 1 wherein the plurality of coated garnet particles are configured to be mixed into tire rubber formulations at a ratio of between 5 and 15 percent by weight of tread rubber formulation.

3. The coated garnet particle product of claim 1 wherein at least some individual coated garnet particles of the plurality of coated garnet particles range in size between 8-200 mesh sizing.

4. The coated garnet particle product of claim 1 wherein the bonding agent is a bonding agent for elastomers that includes at least a polymer-adhesive organic solvent.

5. The coated garnet particle product of claim 4, wherein the polymer-adhesive organic solvent includes at least a nitrogen substituted aromatic crossliner of a natural or a synthetic blend.

6. The coated garnet particle product of claim 1, wherein the at least one coating includes at least an additional coating that includes at least a silane primer, wherein the silane pimer of the at least an additional coating is adhered directly to the garnet particles and the bonding agent of the at least one coating is adhered at least one of to the silane primer or to the garnet particles.

7. The coated garnet particle product of claim 6, wherein the silane primer of the at least an additional coating is a residue remaining on at least some portions of at least some the garnet particles after evaporation of at least some of the silane primer prior to an application of the bonding agent.

8. The coated garnet particle product of claim 6, wherein the silane primer includes at least an oil-derived or synthetic polymer that is configured to prepare the plurality of garnet particles for the bonding agent.

9. The coated garnet particle product of claim 8, wherein the oil-derived or synthetic polymer includes at least an organofunctional silane.

10. The coated garnet particle product of claim 9, wherein the organofunctional silane includes at least one or more of toluene, n-butanol, or an ethanol.

11. The coated garnet particle product of claim 1, wherein the at least one coating is only a single coating that includes at least the silane primer and the at least one coating does not include any additional coatings.

12. A garnet tire that provides secure gripping on a variety of road conditions, including on icy, snowy, wet, and dry road conditions, the garnet tire comprising:
a tire tread;
a plurality of coated garnet particles embedded throughout the tire tread of said garnet tire and at least some of the plurality of coated garnet particles partially protruding from a tire tread surface of said tire tread for gripping one or more road surfaces when the garnet tire is mounted to a moving motor vehicle for operation on the one or more road surfaces, the plurality of coated garnet particles including at least one coating that individually coats the garnet particles of the plurality of garnet particles and that includes at least a bonding agent configured to adhere to elastomers under heat and pressure of a vulcanization process, and
wherein because of the at least one coating the coated garnet particles adhere more strongly to the tire tread of the tire relative to uncoated garnet particles, wherein loss of coated garnet particles from road friction is reduced relative to a tire having uncoated garnet particles, and wherein the coated garnet particles configure the tire for an increased gripping capability on road surfaces relative to a gripping capability of a tire with uncoated garnet particles.

13. The garnet tire of claim 12, wherein the garnet tire is one of a truck tire or a passenger tire.

14. The garnet tire of claim 12, wherein the garnet tire is at least one of a retread tire or a new tire.

15. The garnet tire of claim 12, wherein the at least one coating includes at least an additional coating that includes at least a silane primer, wherein the silane primer of the at least an additional coating is adhered directly to the garnet particles and the bonding agent of the at least one coating is adhered at least one of to the silane primer or to the garnet particles.

16. A method of manufacturing a coated garnet particle product, the method comprising:
rinsing a plurality of garnet particles;
applying a forced air stream to the plurality of garnet particles to create a static charge on the plurality of garnet particles;
mixing the plurality of garnet particles with at least a silane primer and allowing to dry, the plurality of garnet particles being mixed with a silane primer that is an oil-derived or synthetic polymer that is configured to further clean the plurality of garnet particles and prepare the plurality of garnet particles for application of a bonding agent for elastomers; and
mixing the plurality of garnet particles with at least the bonding agent for elastomers and allowing to dry.

17. The method of claim 16, wherein mixing the plurality of garnet particles with the at least a silane primer includes at least mixing the plurality of garnet particles with an organofunctional silane.

18. The method of claim 17, wherein mixing the plurality of garnet particles with the organofunctional silane includes at least mixing the plurality of garnet particles with an organofunctional silane that includes one or more of toluene, n-butanol, or an ethanol.

19. The method of claim 16, wherein mixing the plurality of garnet particles with the at least a bonding agent for elastomers includes at least mixing the plurality of garnet particles with a nitrogen substituted aromatic crossliner of a natural or a synthetic blend.

20. The method of claim 16, wherein mixing the plurality of garnet particles with at least a silane primer comprises:
at least one of dipping the plurality of garnet particles in the silane primer or spraying the silane primer on the plurality of garnet particles.
